(19) United States
(12) Patent Application Publication
(10) Pub. No.: US 2003/0155862 A1
(43) Pub. Date: Aug. 21, 2003

(54) Plasma display device

(76) Inventor: Shinichiro Shirozu, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/220,152

(22) PCT Filed: Dec. 28, 2001
(86) PCT No.: PCT/JP01/11602

(30) Foreign Application Priority Data
Dec. 28, 2000 (JP) 2000-401611

(51) Int. Cl. H01J 17/49

(52) U.S. Cl. 313/582

(57) ABSTRACT

Provided is a plasma display device which can realize displaying with high fineness and high brightness, and has low power consumption and high reliability. On a front glass substrate (12), a sustain electrode pair (17a) and (17b) with a thickness such as 40 μm are located. The thickness is sufficient to allow opposite surfaces of the sustain electrode pair (17a) and (17b) to become substantial discharge surfaces, and discharge paths at this time form a straight line shape between the opposite surfaces. Therefore, metastable particles produced by discharges have low probability of moving away from a space between these opposite sides towards the circumferences, and can maintain a long life as a whole.

### TECHNICAL FIELD

The present invention relates to a plasma display device which displays using plasma discharges.

### BACKGROUND ART

Displays for personal computers and the like desire space-saving and portability improvement, because of affects of a massive flow of light-weight thin models in recent years, and various FPDs (Flat Panel Display) such as LCD (Liquid Crystal Display), FED (Field Emission Display), organic EL (Electroluminescence) display, and PDP (Plasma Display Panel), are developed and produced commercially.

Of them the plasma display panels (PDPs), which display images by irradiating phosphors with ultraviolet rays generated by plasma discharges to emit light, are expected to develop a market for thin large screen displays using thereof.

The PDPs can be divided by discharge voltages into major categories: a direct current (DC) drive type and an alternate current (AC) drive type. DC type PDPs apply direct current voltages between a negative electrode and a positive electrode, which are located on two substrates facing each other, for discharging, and display only while applying the voltages. On the other hand, AC type PDPs apply alternate current pulse voltages between a pair of discharge electrodes to discharge, accumulate electric charges in a dielectric layer and a protective layer (MgO layer) over the electrodes to have a binary memory function. Moreover, the AC type PDPs have categories: an opposite discharge type where two discharge electrodes are respectively located on two substrates facing each other like the DC type, and a surface discharge type where two discharge electrodes are located in parallel on one of two substrates.

FIG. 13 shows a schematic configuration of a conventional surface discharge type plasma display device 100. Here, a basic structure including a part corresponding to one unit picture element (pixel) is shown.

The plasma display device 100 has a rear glass substrate 101 and a front glass substrate 102 positioned on a display side, which are located in the opposite direction, and a peripheral part hermetically sealing a space therebetween. Two or more address electrodes 103 are arranged in parallel on the rear glass substrate 101, a dielectric layer 104 is located to cover these address electrodes 103, and thereon, stripe-shaped barriers 105 are arranged. For each of the address electrodes 103, an upper space thereover is divided by the barriers 105, and phosphors 106 of three primary colors, i.e., red, green, and blue, are alternately located in gaps between the barriers 105 directly over the address electrodes 103.

On the other hand, a pair of sustain electrodes 107 (107a, 107b) for the surface discharging are located on the front glass substrate 102. Bus electrodes 110 (110a, 110b) for reducing electric resistance are respectively located on the sustain electrodes 107a and 107b integrally. And, the sustain electrodes 107 are arranged to be perpendicular to the extended direction of the address electrodes 103, and the sustain electrodes 107 and the address electrodes 103 form a matrix. In addition, a dielectric layer 108 and a protective layer 109 made of MgO film are located in this order on the sustain electrodes 107. The dielectric layer 108 constitutes a condenser for limiting discharge currents, and has a function to hold the accumulated electric charges for a specified time. The protective layer 109 has functions such as protecting the dielectric layer 108 and the sustain electrode 107 from sputtering by discharge plasma, increasing a secondary electron emission coefficient to lower a firing voltage, limiting excessive discharge currents, and maintaining a discharge state.

In the plasma display device 100, between the rear glass substrate 101 and the front glass substrate 102 is a discharge space, and mixed gas or single gas, which is selected from neon, xenon, and the like, is enclosed there as a discharge gas. The discharge space is divided by the barriers 105, and in the discharge space, a dot (a minimum light emitting unit) 112 is formed on each intersection between the paired sustain electrodes 107 and the address electrodes 103 which are arranged into the matrix shape. Furthermore, one unit picture element (pixel) 113 is composed of three adjoining dots 112 respectively having red, green, and blue phosphors 106.

FIG. 14 is a sectional view taken along VII-VII line of FIG. 13. In the plasma display device 100, first, wall charges are accumulated selectively on parts of the protective layer 109 which are corresponded to dots 112 where light is to be emitted, and then, an alternating voltage is applied between the pair of the sustain electrodes 107a and 107b. When the voltage resulting from the wall charges is added to the alternating voltage in such way, the voltage across the sustain electrodes 107a and 107b reaches a firing voltage, and a discharge (sustain discharge) is generated. The phosphors 106 of the dots 112 are exposed to ultraviolet rays which are emitted from the discharge gas as a result of the above discharge, and the dots 112 emit light, resulting in performing a display.

Based on this principle, drive sequences of the plasma display device 100 are divided into a selective write operation and a selective erase operation according to a selection method of the dots 112 to be displayed. According to the selective write operation, first, pulses are applied to these sustain electrodes 107a and 107b alternately, and all the dots 112 are initialized to a state where wall charges are uniform. In this state, the display in the whole surface is erased. Next, discharging (address discharging) is performed between either of the sustain electrodes 107a and 107b, and the address electrode 103 only in the dots 112 which is to be displayed, to accumulate wall charges on the protective layer 109. When applying an alternating voltage across sustain electrodes 107a and 107b at this condition, only the dots 112 having the wall charges acquire a firing voltage to create discharges (sustain discharges).

On the other hand, according to the selective erase operation, first, discharging is performed between the sustain electrodes 107a and 107b in all the dots 112, the whole surface for discharging emits light, and wall charges are uniformly accumulated on the protective layer 109. Next, discharging (address discharging) is performed between either of the sustain electrodes 107a and 107b and the address electrode 103 with polarity opposite to the above discharging only in the dots 112 which is not to be displayed, and the wall charges are erased. As a result, the wall charges remain only in the dots 112 which should be displayed, and after that, displaying is performed like the selective write operation.

By the way, these surface discharge type PDPs have categories of a negative glow discharge-using type and a cathode glow discharge-using type. The negative glow is generated in a position further away from the cathode compared with the so-called Crookes dark space, so it is necessary to set a distance between discharge electrodes to about 100 μm. That is, in this case, a gap (discharging gap) between sustain electrodes 107a and 107b requires a width of 100 μm or more, so that there has been a limit of size reduction in the dots 112. On the other hand, it has been proposed that PDP has much narrower discharging gaps utilizing the cathode glow discharge (for example, Japanese Patent Laid-open No. 10-247474, and the like). While electrons emitted from a cathode is accelerated toward an anode, the electrons at the initial discharging does not interact with gas molecules, and very near the cathode between the electrodes becomes an Aston dark space. When the accelerated electrons start to excite the gas molecules, a part where the excited gas molecules emit light is generated following the Aston dark space. This part is a cathode glow and is nearer to the cathode than a negative glow or a Crookes dark space. Therefore, in the cathode glow discharge, a discharging gap becomes less than 50 μm, and a gap between the sustain electrodes 107a and 107b is set to less than 50 μm.

During the plasma display device 100 operates in such way, particles (metastable particles) in an excited state such as an excimer, metastable atoms, and metastable molecules, are produced in discharge plasma of the sustain discharging. It is thought that these particles have no ability to transit directly to their ground state, resulting in a comparatively long life, and contribute to duration and stabilization of discharges, and reduction of discharge electric power, but lose energy and disappear due to collision with the surrounding barriers 105 while moving in a discharge space.

However, in the conventional plasma display device 100, thin sheet type thin film electrodes have been used for the sustain electrodes 107, so the sustain discharges are produced on the upper surface side of the two sustain electrodes 107a and 107b as shown in FIG. 14, and the discharge paths have a semicircle arch shape connecting the upper surfaces of the sustain electrodes 107a and 107b. This causes high probability of the collision of the metastable particles with the surfaces of the barriers surrounding discharge space, shorter mean free path, and shorter life thereof. Therefore, there have been problems of insufficient real quantity or existence probability of the metastable particles, and of increasing the firing voltage and the discharge sustaining voltage. These increases of the operating voltages become factors which cause problems such as increasing power consumption, overload of component circuits, and generating unusual discharges such as arc discharges.

On the other hand, although it is necessary to reduce an area per dot for improving fineness of the PDPs, a narrower electrode interval increases the operating voltages, so the above problems also occur. Therefore, in the conventional discharge types which can neither obtain the metastable particles stably nor keep drive voltages to a low level, it has also been difficult to avoid the voltage increase accompanying miniaturization thereof.

The present invention has been achieved in view of the above problems. It is an object of the invention to provide a plasma display device which realizes displaying with high fineness and high brightness, and has low power consumption and high reliability.

### DISCLOSURE OF THE INVENTION

A plasma display device according to the present invention has a thickness which allows substantial discharges between surfaces facing each other of electrodes of a sustain electrode pair, and discharges are produced between these opposite sides along a linear discharge path. The thickness of the sustain electrodes are preferably 10 μm or more, more preferably 20 μm or more, and further more preferably 40 μm or more. Moreover, a discharging gap is less than 50 μm preferably.

Other and further objects, features and advantages of the invention will appear more fully from the following description.

### BRIEF DESCRIPTION OF THE DRAWINGS

FIG. 1 is a perspective view showing a schematic configuration of a plasma display device according to a first embodiment of the invention.

FIG. 2 is a sectional view taken along I-I line of the plasma display device shown in FIG. 1.

FIGS. 3A and 3B are plane views for explaining an arrangement of address electrodes and sustain electrodes in a modification of the plasma display device shown in FIG. 1.

FIGS. 4A to 4C are views showing a principal part configuration of a plasma display device according to a second embodiment of the invention.

FIGS. 5A and 5B are examples of a cell arrangement of the plasma display device shown in FIGS. 4A to 4C.

FIGS. 6A and 6B are views showing a principal part configuration of a plasma display device according to a third embodiment of the invention.

FIG. 7 is an example of a cell arrangement of the plasma display device shown in FIGS. 6A and 6B.

FIG. 8 is an example of a cell arrangement of the plasma display device shown in FIGS. 6A and 6B.

FIGS. 9A and 9B are views showing a principal part configuration of a plasma display device according to a fourth embodiment of the invention.

FIG. 10 is an example of a cell arrangement of the plasma display device shown in FIGS. 9A and 9B.

FIG. 11 is a view showing a principal part configuration of a plasma display device according a fifth embodiment of the invention.

FIG. 12 is a view showing a principal part configuration of a plasma display device according the fifth embodiment of the invention.

FIG. 13 is a view showing a configuration of a conventional plasma display device.

FIG. 14 is a view showing a principal part configuration of the conventional plasma display device shown in FIG. 13.

### BEST MODE FOR CARRYING OUT THE INVENTION

Embodiments of the present invention will be described in detail below with reference to accompanying drawings.

[First Embodiment]

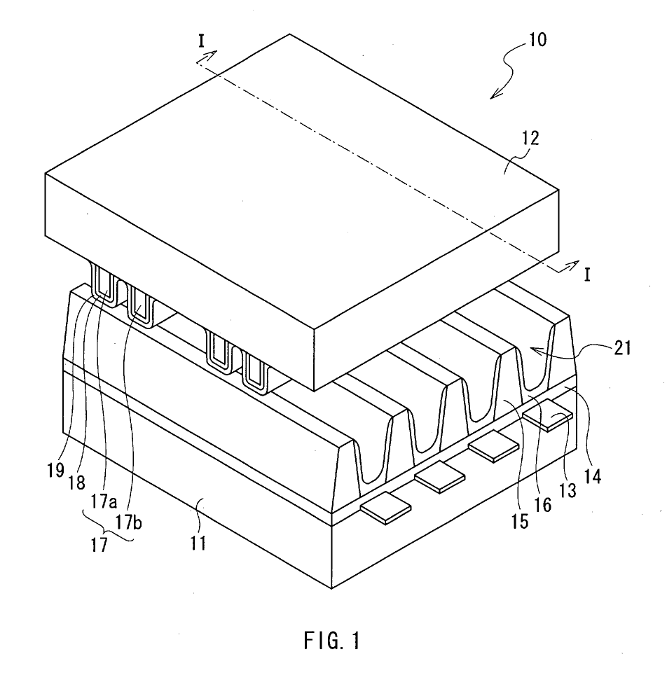

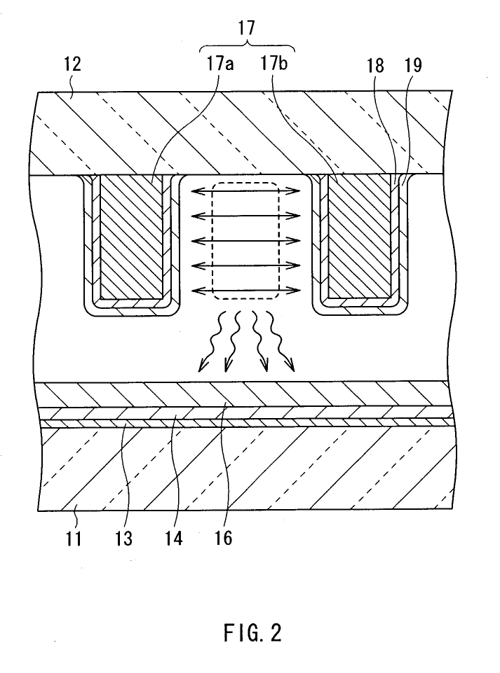

FIG. 1 is a view showing a schematic configuration of a plasma display device according to a first embodiment of the invention, and FIG. 2 is an expanded sectional view taken along I-I line. In the plasma display device 10, each component except for sustain electrodes 17 (17a, 17b), dielectric layers 18, and protective layers 19 which are located on a front glass substrate 12, has a similar structure to that of the conventional plasma display device 100, and a space for discharging is located between a rear glass substrate 11 and the front glass substrate 12 positioned on a display side, which are located in the opposite direction, and a peripheral part is hermetically sealed through a spacer (not shown). Here, it is assumed that an address discharge is a negative glow discharge and a sustain discharge is a cathode glow discharge.

The rear glass substrate 11 is formed from high strain point glass or soda lime glass shaped into a board form, for example. On the rear glass substrate 11, address electrodes 13 made of a metal thin film such as aluminum (Al) are arranged in parallel, and thereon, a dielectric layer 14 is located to cover the address electrodes 13. The dielectric layer 14 is formed by performing vacuum deposition of SiO₂ (silicon dioxide), for example. On the dielectric layer 14, barriers 15 are formed in order to partition a discharge space 21 for each of the address electrodes 13. The barriers 15 have a trapezoid like cross section, and are formed by patterning glass paste and baking it. In addition, the height of the barriers 15 can be adjusted by grinding a top part of the barriers 15, or by shaving the rear glass substrate 11. Phosphors 16 of three primary colors, that is, red, green, and blue, are located alternately on side surfaces of the barriers 15, on exposed surfaces of the dielectric layer 14 and the spaces between two adjacent barriers 15.

On the other hand, the front glass substrate 12 is located on the display side, so it is necessary to use a material with high transparency, and generally high strain point glass or soda lime glass is used as well as the rear glass substrate 11. On the front glass substrate 12, pairs of sustain electrodes 17 (17a, 17b) are located to perpendicularly intersect with an extended direction of the address electrodes 13 which are on the opposite side, and the sustain electrodes 17 and the address electrodes 13 compose a matrix where at intersections thereof are dots.

The sustain electrodes 17 are transparent electrodes made of a material such as ITO (Indium-Tin Oxide), and are formed to have a sufficient thickness to allow opposite surfaces of the paired sustain electrodes 17a and 17b to become substantial discharge surfaces. The thickness of these sustain electrodes 17 is the value which can suitably be adjusted to specifications of the plasma display device 10, and is preferably 10 μm or more. In order to extend the discharge surfaces, it may be set to 20 μm or more, or 40 μm or more. Here, the thickness of the sustain electrodes 17 is set to 40 μm. In this connection, the thickness of the conventional sustain electrodes is within a range of 0.1-1.0 μm. The reason of the thickness of 1 μm or less is that there have been problems that thicker electrodes may be peeled from the substrate, the total time required for deposition thereof is too long, and the like. In addition, the width of the sustain electrodes 17 (namely, the width of the opposite surfaces) is about several μm-20 μm herein.

The sustain electrodes 17 may be composed entirely of an electrode material, and also may be composed of a core such as ceramics which is covered with an electrode material. In this case, the electrode material is located at least on the opposite surfaces, and the sustain electrodes 17 can be more ideally designed, because they are difficult to be peeled from the substrate 12. Particularly, in the case of the ideal form with a thickness of 40 μm or more, such composition allows easy formation thereof and is preferred.

Moreover, because of the cathode glow discharge, each gap (discharging gap) between the paired sustain electrodes 17a and 17b is less than 50 μm, and is preferably set to 40 μm or less, and still more preferably 20 μm or less. In addition, a distance between one pair of sustain electrodes 17a and 17b and another adjoining pair of the sustain electrodes 17a and 17b is 20 μm or more in order to prevent the so-called cross talk among the dots. Furthermore, bus electrodes (not shown) made of a metal such as Al (aluminum) can be provided as an adjunct to the sustain electrodes 17a and 17b for reducing electric resistance.

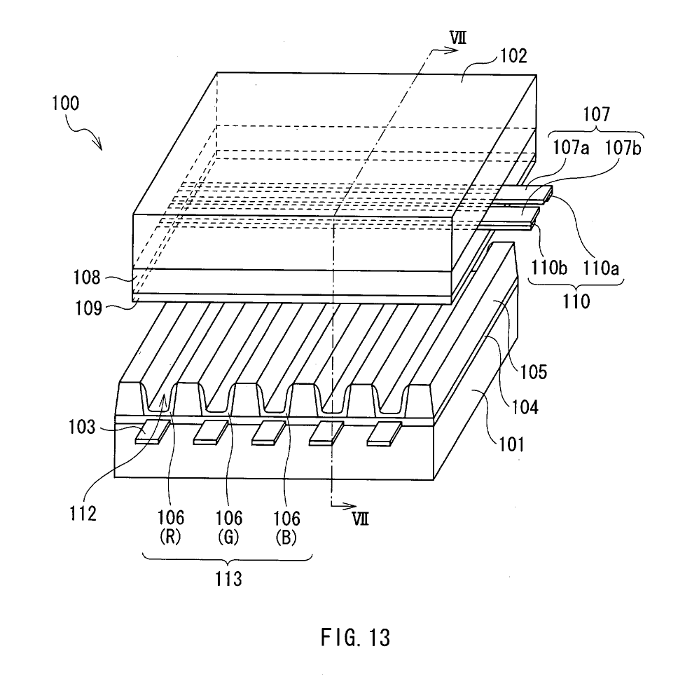

In the conventional device as described in FIG. 13, the dielectric layer 108 and the protective layer 109 have been located to cover from the sustain electrodes 107 to the whole surface of the front glass substrate 102. But in the embodiment, the dielectric layer 18 and the protective layer 19 are located to cover only each of the sustain electrodes 17. The dielectric layer 18 and the protective layer 19 made of a low melting glass and MgO (magnesium oxide), respectively.

In addition, mixed gas or single gas, which is selected from neon, xenon, and the like, is enclosed as a discharge gas in the discharge space located among the pairs of the sustain electrodes 17a and 17b on the front glass substrate 12 and the address electrodes 13 on the rear glass substrate 11, and the discharge space partitioned by the barriers 15 provides each discharge cell and emits light at every dot.

Next, operations of the plasma display device 10 will be described with reference to FIGS. 1 and 2.

Here, the selective erase operation is selected as a drive operation. First, alternate current pulse voltages are applied across the sustain electrodes 17a and 17b of each pair. The voltage for one electrode is about +200 V and the voltage for the other is about −200 V. Thereby, wall charges are uniformly accumulated on the protective layer 19 in all the discharge cells, and the whole cell surface is reset. Next, in the discharge cells of the dots which are not to be displayed, discharge address voltages are applied to the sustain electrodes 17 and the address electrode 13, the negative glow discharge (address discharge) is performed to erase the wall charge there. The discharge address voltage applied to each of the sustain electrodes 17a and 17b at this time has opposite polarity to the discharge for the initialization. For example, on the sustain electrodes 17 side, −100 V and 0 V are respectively applied to the electrodes to which +200 V and −200 V are applied in the previous discharging, and the voltage of the address electrode 13 is set to +70 V. Thereby, the wall charges remain only in the dots which should be displayed.

Next, alternating voltages are applied across the sustain electrodes 17a and 17b in the above state, and then, only the dots 112 having the wall charges reach a firing voltage because of adding the alternating voltage to the wall charge voltage, and surface discharges (sustain discharges) by cathode glow discharge are generated in the discharging gaps. The discharge sustaining voltages applied at this time are, for example, the alternating voltages of ±160 V respectively to the sustain electrodes 17a and 17b.

Here, in the embodiment, the sustain electrodes 17a and 17b with a sufficient thickness are formed, so the discharges are substantially generated in the opposite surfaces facing each other of the side surfaces. In this case, discharge paths between the two discharge surfaces have a straight line shape to perpendicularly intersect with the opposite surfaces. Therefore, the metastable particles produced by the discharges exist only between the sustain electrodes 17a and 17b, and have low probability of moving to the circumferences of the discharge cells. Thereby, the metastable particles can maintain a metastable state for a long time as a whole.

Furthermore, the discharge paths are parallel to surfaces of the phosphors 16, and continue along the extended direction of the sustain electrodes 17a and 17b in the discharging gaps. Therefore, the discharge plasma is generated and formed into a plane shape parallel to the surface of the phosphors 16 in an area surrounded by a dotted line shown in FIG. 2. In addition, since the dielectric layer 18 and the protective layer 19 cover only the sustain electrodes 17a and 17b, discharges occur also below the sustain electrodes 17a and 17b.

The plasma discharges allow the discharge gas in the discharge space to radiate ultraviolet rays, the phosphors 16 are irradiated with the ultraviolet rays, and the phosphors 16 are excited and emit light to display the dots.

The plasma display device 10 according to the embodiment is formed into a steric structure with the thickness (40 μm) to produce the discharges between the opposite surfaces facing each other of the sustain electrodes 17a and 17b, so the sustain discharges are generated in the linear shape between these opposite surfaces, and the metastable particles produced by the discharges also exist only between the opposite surfaces. Therefore, the metastable particles have increased existence probability, and can maintain a comparatively long life, so the firing voltage and the discharge sustaining voltages can be reduced.

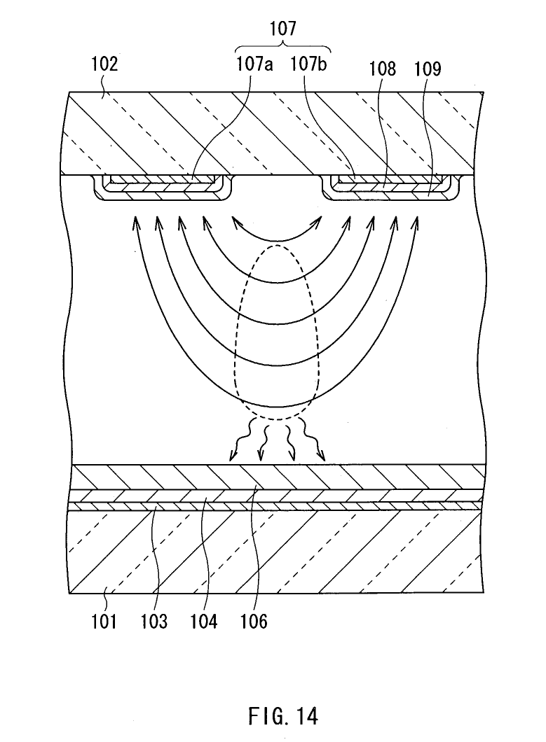

Moreover, since the discharges are produced linearly between the opposite surfaces, discharges are generated over the whole domain of discharging gaps to provide efficient discharges, and the height of the discharge cells can be lowered without degrading the phosphors 16. In this connection, in the conventional case, as shown in FIG. 14, the sustain discharges are produced in the arc shape between the upper surfaces of the sustain electrodes 107a and 107b as mentioned above, so the phosphors 106 are subject to degeneration due to arch peaks of the plasma. Also, in order to prevent this, the discharge cells should be high to keep each distance between the sustain electrodes 107 and the phosphors 106. In addition, in the conventional case, the discharge plasma has been produced and concentrated mainly in the center of the discharge path, i.e., a top part of the arch (an area surrounded by the dotted line in FIG. 14), and the plasma which contributes to light emitting substantially is produced in a linear shape in the arch top, although it is called the surface discharge type using coplanar electrode pairs.

On the other hand, in the embodiment, the discharge paths of the sustain discharges produced between the sustain electrodes 17a and 17b are parallel to the surface of the phosphors 16, which allows all the discharges on the discharge paths to contribute to light emitting. Particularly, the discharge plasma is generated in the plane shape in parallel to the surface of the phosphors 16 herein, which allows the discharges to contribute to the light emitting efficiently.

Furthermore, the dielectric layer 18 and the protective layer 19 cover only the sustain electrodes 17a and 17b, so the discharges occur also below the sustain electrodes 17a and 17b, and the discharging gaps can be effectively used for discharging.

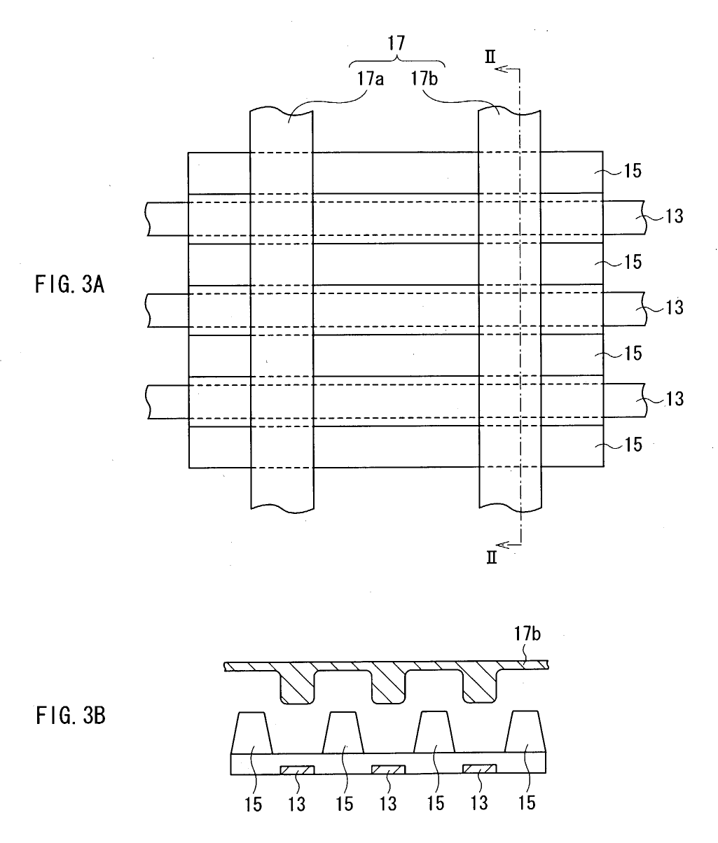

Next, a modification of the above first embodiment will be described. FIGS. 3A and 3B show an arrangement of the address electrodes 13 and the sustain electrodes 17 in the modification, FIG. 3A is a plane view, and FIG. 3B is a sectional view taken along II-II line. In this case, the sustain electrodes 17 are formed with a thickness (for example, 40 μm) to produce discharges between the opposite surfaces of the sustain electrodes 17, which have paired parts only in areas intersecting with the address electrodes 13 perpendicularly to form the dots, and for example, the other parts are very thin as usual. Therefore, the sustain discharge is locally produced in targeted dot positions. Therefore, the cross talk between the adjacent dots due to the transfer of the charges can be reduced.

[Second Embodiment]

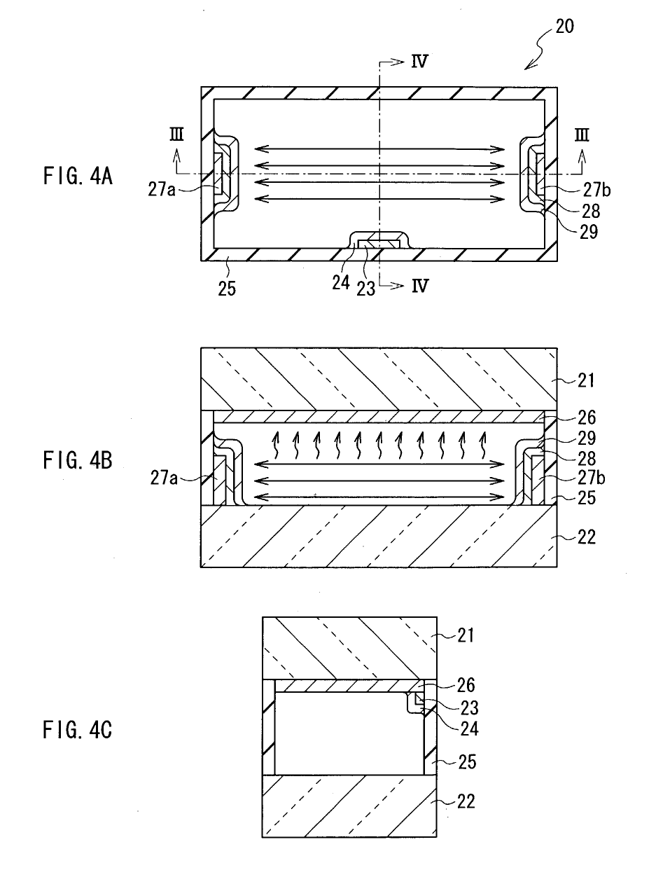

FIGS. 4A to 4C are views showing a principal part configuration of a plasma display device according to a second embodiment of the invention. FIG. 4A is a plane view, FIG. 4B is a sectional view taken along III-III line, and FIG. 4C is a sectional view taken along IV-IV line. In the plasma display device, a discharge space is divided into cell-like compartments by barriers 25, and each internal discharge space thereof constitutes a closed discharge cell 20, and island-like sustain electrodes 27a and 27b are formed on a front glass substrate 22 so that both are respectively in contact with two opposite sides of the barriers 25. Moreover, an island-like address electrode 23 is formed on a phosphor 26 in contact with one of the other sides of the barriers 25. In addition, the phosphor 26 is formed on a rear glass substrate 21.

Here, the sustain electrodes 27a and 27b are formed into a steric structure with a thickness to produce discharges between opposite surfaces facing each other of the sustain electrodes 27a and 27b, and for example, the thickness is set to 40 μm. Furthermore, the thickness is preferably 10 μm or more, and it can suitably be selected within a range of 10 μm-100 μm. Moreover, a width thereof is preferably within a range of about several μm-20 μm, and for example, it can be set to about 10 μm. Furthermore, a discharging gap between the sustain electrodes 27a and 27b is set to less than 50 μm like the first embodiment, preferably 40 μm or less, and more preferably 20 μm or less, and simultaneously a distance between the barriers 25 in contact with the sustain electrodes 27 of the cell is determined.

On the other hand, the address electrode 23 is located to be positioned mostly in a center of one of the surfaces except for the two sides which are in contact with the sustain electrodes 27 on the barriers 25 herein. It should be noticed that the address electrode 23 may be any electrode which has a function of producing address discharges in a space extended to the sustain electrodes 27, it is not necessarily to be located in the above position, and the form thereof can also be a linear like the first embodiment. In addition, each of the above address electrode 23 and sustain electrodes 27 is covered with dielectric layer 24.

In such a plasma display device, sustain discharges are generated inside each discharge cell 20 as shown in FIGS. 4A and 4B. That is, the discharges are generated between the opposite surfaces of the sustain electrodes 27a and 27b which are independently located with the island-like shape inside the cell 20, and discharge paths between the two discharge surfaces have a straight line shape intersecting perpendicularly with the opposite surfaces. Therefore, metastable particles produced by the discharges exist only between the sustain electrodes 27a and 27b, and have low probability of moving to the circumferences of the discharge cell. Thereby, the metastable particles can maintain a metastable state for a long time as a whole.

Furthermore, also in the embodiment, the discharge paths are parallel to a surfaces of the phosphor 26, the dielectric layers 24 cover only the sustain electrodes 27a and 27b, so discharges occur also below the sustain electrodes 27a and 27b, and the discharges are generated using the discharging gap effectively.

The plasma discharges allow discharge gas to radiate ultraviolet rays, the phosphor 26 is irradiated with the ultraviolet rays, and the phosphor 26 is excited and emits light to display the dots.

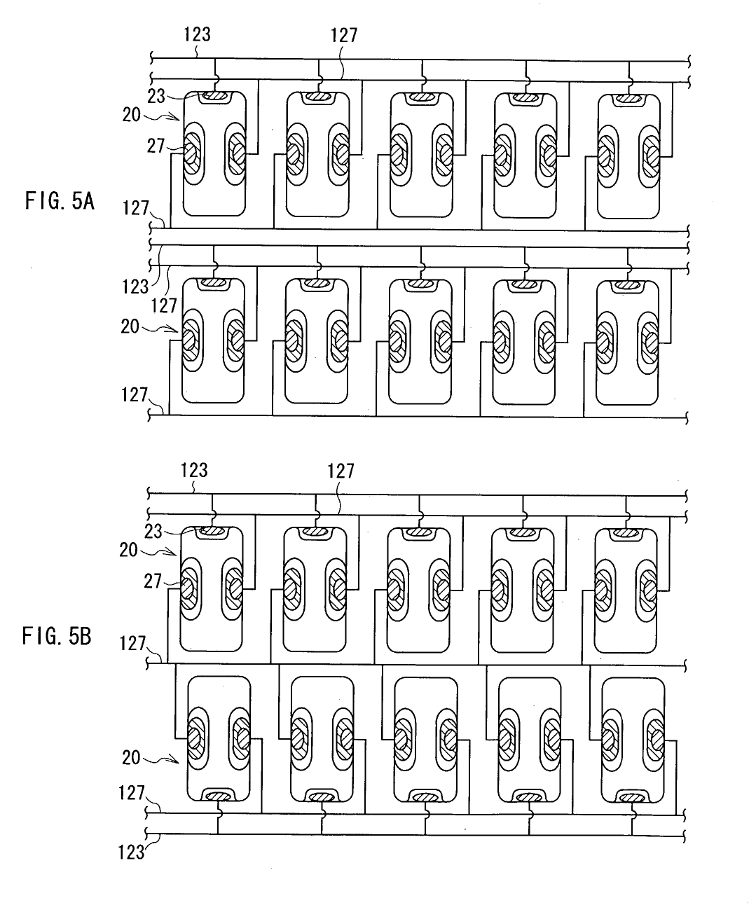

FIGS. 5A and 5B are examples of the plasma display device with a configuration using these discharge cells 20. In FIGS. 5A and 5B, the address electrodes 23 and the sustain electrodes 27 connect respectively to address electrode wirings 123 and sustain electrode wirings 127, and each discharge cell is driven through these address electrode wirings 123 and sustain electrode wirings 127.

While in the above first embodiment, the discharge plasma is generated in the surface parallel to the surface of the phosphor 16, the discharge plasma is generated in a linear-shape across the sustain electrodes 27a and 27b which are facing each other in the present embodiment. That is, except for this point, the action effects of the present embodiment are the same as those of the first embodiment.

[Third Embodiment]

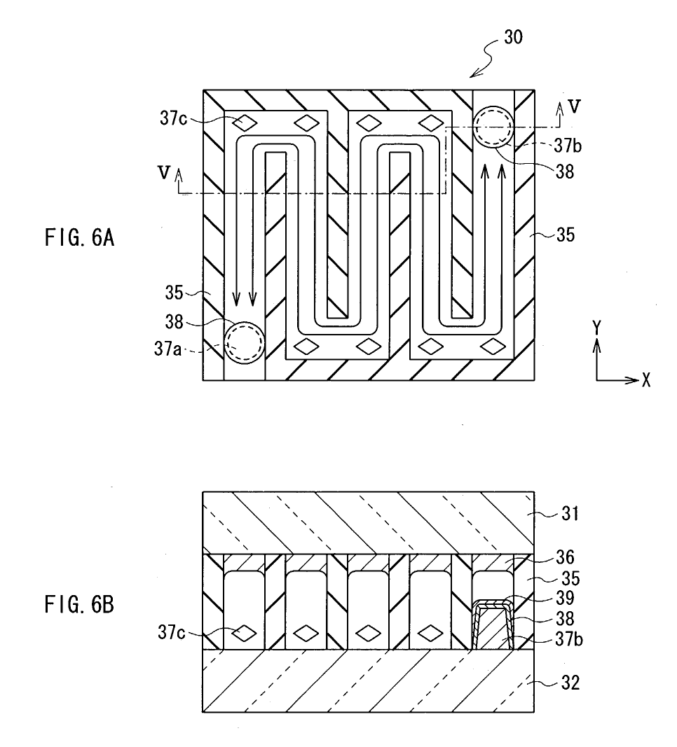

FIGS. 6A and 6B are views showing a principal part configuration of a plasma display device according to a third embodiment of the invention. FIG. 6A is a plane view, and FIG. 6B is a sectional view taken along V-V line thereof. In the plasma display device, a pair of comb-shaped barriers 35 facing each other is combined to be engaged, and a discharge space is divided in an X direction and a Y direction by barriers 35 as shown in the figure. That is, one discharge cell 30 has a structure where a long and slender discharge space is bent by the barrier 35 and island-like sustain electrodes 37a and 37b are formed in both ends of the discharge space. Moreover, as shown in FIG. 6A, discharge auxiliary electrodes 37c are located in bending parts of the discharge space of the barriers 35 herein.

All of these sustain electrode 37a and 37b and these discharge auxiliary electrodes 37c are formed on a front glass substrate 32. Of them the sustain electrodes 37a and 37b are formed with a thickness sufficient to generate discharges on an adjacent surface facing the discharge auxiliary electrode 37c in the Y direction between the adjoining electrodes, and the thickness can be set to 40 μm. On the other hand, the discharge auxiliary electrodes 37c are also formed with a thickness sufficient to generate discharges on opposite surfaces between the electrodes facing each other, and the thickness can be set to 40 μm. It should be noticed that the discharge auxiliary electrodes 37c are provided in order to perform pilot discharges in a moment, so the thickness may be several μm-about 10 μm. Moreover, each of the sustain electrodes 37a and 37b and discharge auxiliary electrodes 37c are covered with a dielectric material 38 and a protective layer 39.

In addition, a phosphor 36 and an address electrode, which is not illustrated, are located between the barriers 35 on a rear glass substrate 31. Here, the address electrode can be any electrode which has a function of producing address discharges in a space extended to the sustain electrodes 37, and positions and forms thereof are arbitrarily selected.

Discharge paths between such sustain electrodes 37a and 37b have a polygonal line which is formed to be led by the discharge auxiliary electrodes 37c along the discharge space in the cell 30. Moreover, the discharging gaps between the sustain electrodes 37a and 37b and the adjacent discharge auxiliary electrodes 37c in the Y direction are set, for example, to less than 50 μm like the first embodiment, preferably 40 μm or less, and more preferably 20 μm or less, and a length in the Y direction of the barriers 35 of the cell is determined simultaneously.

In the plasma display device comprising the discharge cells 30 with such a configuration, discharges are led along the longitudinal direction of the discharge cell 30 through the discharge auxiliary electrodes 37c, and sustain discharges are generated between the opposite sides of the sustain electrodes 37a and 37b, as shown in FIG. 6A. Also in this case, the discharge paths between the two discharge surfaces have a shape of a straight line in the direction parallel to the surface of the front glass substrate 32, so metastable particles produced by the discharges exist only between the sustain electrodes 37a and 37b, and have low probability of moving to the circumferences of the discharge cell 30. Thereby, the metastable particles can maintain a metastable state for a long time as a whole.

The plasma discharges allow a discharge gas to radiate ultraviolet rays, the phosphor 36 is irradiated with the ultraviolet rays, and the phosphor 36 is excited and emits light to display the dots.

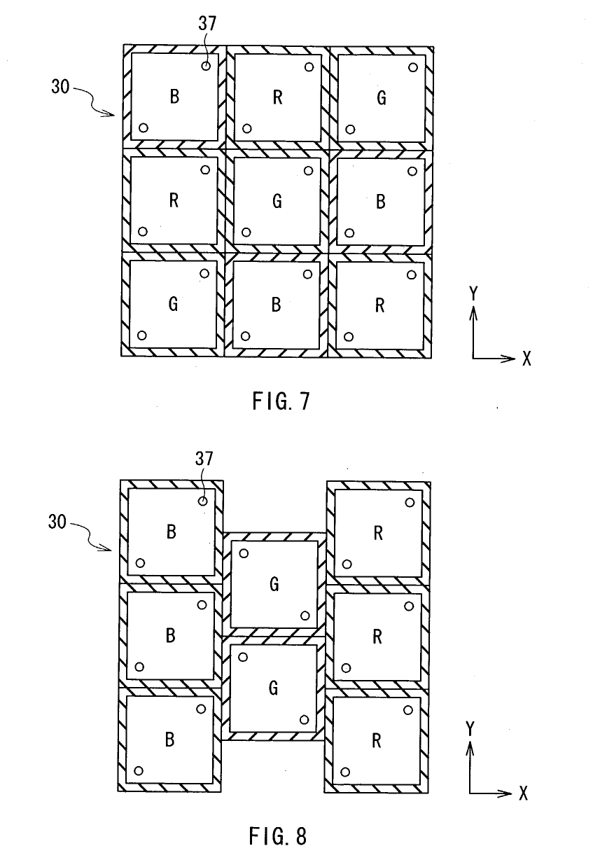

FIGS. 7 and 8 are examples of a cell arrangement of a plasma display device with a configuration using these discharge cells 30. In FIG. 7, all the discharge cells 30 are arranged into a lattice shape in the same direction, and the three primary colors of the phosphors 36, that is, R (red), G (green) and B (blue), are repeated alternately to the both directions of X and Y.

In FIG. 8, the discharge cells 30 are arranged to align the width in the Y direction in parallel, and to shift the half width of the cell in the X direction to have an alternate arrangement between the adjoining discharge cells. Moreover, directions of the cells 30 in the Y direction are mirror symmetry each other, and R (red), G (green), and B (blue) of the phosphors 36 are repeated alternately in the X direction, and the same color is arranged in the Y direction.

In the embodiment, the discharge auxiliary electrodes 37c are provided, which allows the discharge paths to be bent in arbitrary positions, and increases design freedom for an interior of the discharge cells. The other action effects are the same as those of the second embodiment.

[Fourth Embodiment]

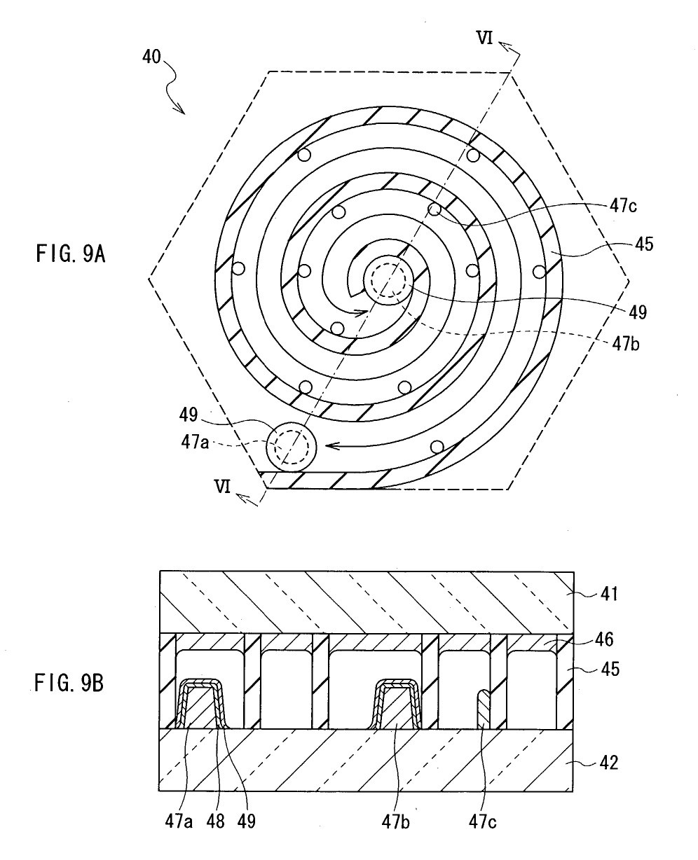

FIGS. 9A and 9B are views showing a principal part configuration of a plasma display device according to a fourth embodiment of the invention. FIG. 9A is a plane view, and FIG. 9B is a sectional view taken along VI-VI line. Here, in one discharge cell 40, a barrier 45 has a spiral shape and island-like sustain electrodes 47a and 47b are respectively located in both terminal sections in a central part and an exterior of the barrier 45. Moreover, discharge auxiliary electrodes 47c are located on an inner side wall of the barrier 45 so that discharges may be generated along a spiral discharge path as shown in the figure.

All of these sustain electrodes 47a and 47b and these discharge auxiliary electrodes 47c are formed on a front glass substrate 42. Like the third embodiment, the sustain electrodes 47a and 47b are also formed with a thickness sufficient to generate discharges on an adjacent surface, which faces the discharge auxiliary electrode 47c along the longitudinal direction of a discharge space, between the adjoining electrodes, and the thickness can be also set to 40 μm herein. The discharge auxiliary electrodes 47c are also formed with a thickness sufficient to generate discharges on opposite surfaces between the electrodes facing each other, and the thickness can be set to 40 μm. It should be noticed that the discharge auxiliary electrodes 47c are located in order to perform pilot discharges in a moment, so the thickness may be several μm-about 10 μm. Each of the sustain electrodes 47a and 47b and the discharge auxiliary electrodes 47c are covered with a dielectric material 48 and a protective layer 49.

In addition, a phosphor 46 and an address electrode, which is not illustrated, are located between sides of the barrier 45 on a rear glass substrate 41. Here, the address electrode can be any electrode which has a function of producing address discharges in a space extended to the sustain electrodes 47, and positions and forms thereof are arbitrarily selected.

In the plasma display device comprising the discharge cells 40 composed of such composition, sustain discharges are generated between the opposite sides of the sustain electrodes 47a and 47b, by discharging in the spiral path along the longitudinal direction of the discharge cells through the discharge auxiliary electrodes 47c as shown in FIG. 9A. Also in this case, the discharge paths between the two opposite surfaces have a shape of a straight line in the direction parallel to the surface of the front glass substrate 42, so metastable particles produced by the discharges, exist only between the sustain electrodes 47a and 47b, and have low probability of moving to the circumferences of the discharge cell. Thereby, the metastable particles can maintain a metastable state for a long time as a whole.

The plasma discharges allow a discharge gas to radiate ultraviolet rays, the phosphor 46 is irradiated with the ultraviolet rays, and the phosphor 46 is excited and emits light to display the dots.

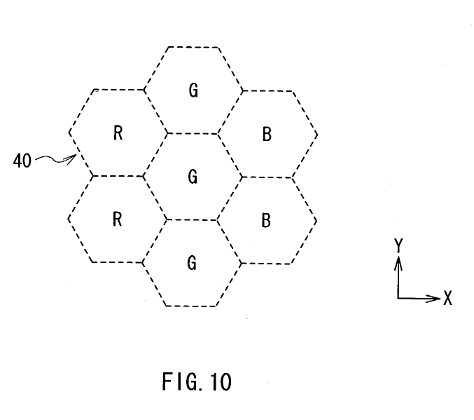

FIG. 10 is an example of a cell arrangement of the plasma display device with a configuration using these discharge cells 40. Here, an appearance of the discharge cell 40 is viewed as a hexagon as expressed by the dotted line in FIG. 9A, and each discharge cell is arranged to form a honeycomb shape. Moreover, R (red), G (green), and B (blue) of the phosphors 46 are repeated alternately in the X direction, and the same color is arranged in the Y direction.

In the embodiment, the discharge auxiliary electrodes 47c are provided, which allows the discharge paths to be curved, and increases design freedom for an interior of the discharge cells. The other action effects are the same as those of the second embodiment.

[Fifth Embodiment]

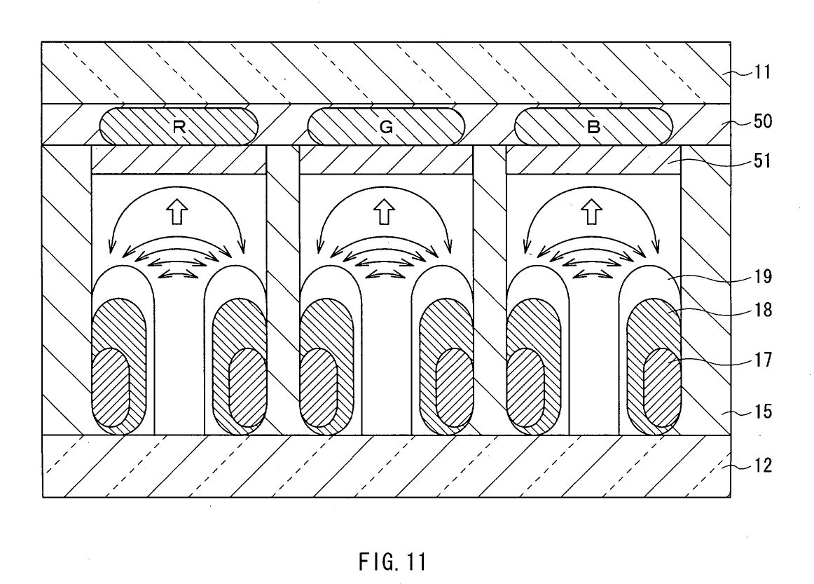

FIG. 11 is a view showing a principal part configuration of a plasma display device according to a fifth embodiment of the invention. The plasma display device in the embodiment has the same configuration as the first embodiment except for providing a phosphor 50 and phosphor protective layers 51, and the same components are represented with the same sign, and the explanation thereof are omitted.

Here, a phosphor 50 is formed into a layer shape on the rear glass substrate 11, the phosphors of R (red), G (green), and B (blue) are arranged on parts corresponding to upper surfaces of discharge cells, and the other parts are consisting of black matrices such as carbon. On the phosphor 50, the phosphor protective layers 51 are formed to close openings among the barriers 15 located in a striped shape. The phosphor protective layers 51 can be formed from glass or silicon (Si), and the thickness can be set to about 50 μm.

In the embodiment, the phosphor protective layers 51 are formed on the phosphor 50, so the phosphor 50 can be in contact with excited gas particles and hot electrons to be changed into plasma during discharging, which prevents the degradation thereof.

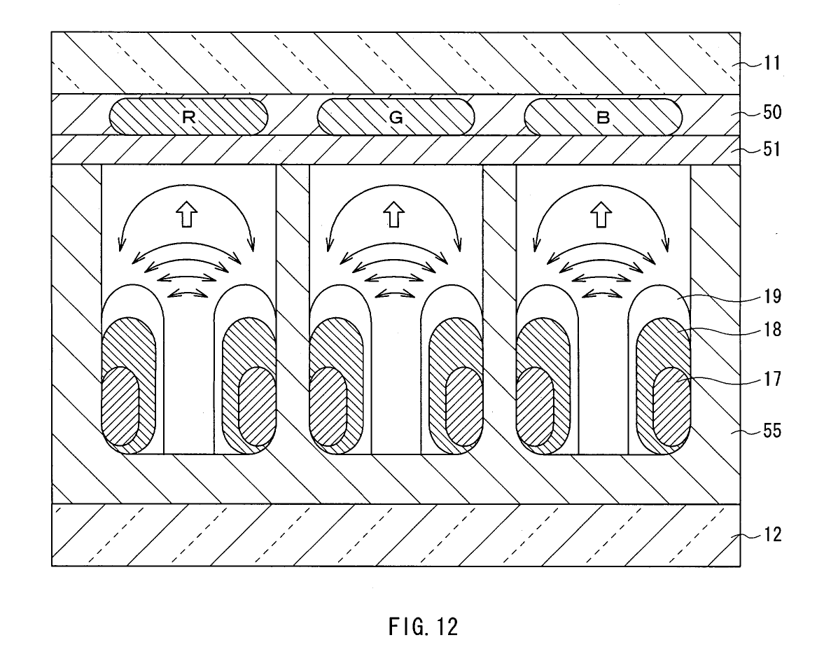

Moreover, as shown in FIG. 12, the phosphor protective layer 51 with a layer shape may be located all over the phosphor 50, and furthermore barriers 55 may be located. The barriers 55 are formed also on the front glass substrate 12 side to surround the periphery of the discharge cells. These barriers 55 can be formed by shaving glass substrates with a specified thickness, or etching Si substrates and a location thereof on the front glass substrate 12 facilitate producing the device.

Although the invention has been described by the foregoing embodiments, the invention is not limited to the embodiments but can be variously modified. For example, while the negative glow discharge is used for the address discharging and the cathode glow discharge is used for the sustain discharging as the discharge type, and the discharging gaps are less than 50 μm and preferably 20 μm or less in the above embodiments, the cathode glow discharge can also be used for both of the address discharging and the sustain discharging. Moreover, when using the negative glow discharge for the two discharging, about 100 μm can be selected for the discharging gaps, which allows a plasma display device to have a similar configuration. Thus, the invention can be widely applied to plasma display devices regardless of the discharge types.

As described above, according to the plasma display device of the invention, the two paired sustain electrodes have the thickness to provide the substantial discharging on the opposite surfaces thereof, so the sustain discharges are generated in the linear shape between these opposite surfaces, and the metastable particles produced by the discharges exist only between the opposite surfaces, which enables a comparatively long life to be maintained. Therefore, displaying with high fineness and high brightness can be realized, and furthermore, stability of the operations can be improved, power consumption can be lowered, and miniaturization can be accomplished, because of the reductions of the firing voltage and the discharge sustaining voltages.

Obviously many modifications and variations of the present invention are possible in the light of the above teachings. It is therefore to be understood that within the scope of the appended claims the invention may be practiced otherwise than as specifically described.

1. A plasma display device comprising a phosphor layer being located on one of two substrates located in the opposite direction and a sustain electrode pair on the other substrate, which are adjacent through a discharging gap,
wherein the sustain electrode pair has a thickness to provide substantial discharging between opposite surfaces of both of the electrodes.

2. A plasma display device according to claim 1, wherein the discharging between the electrodes of the sustain electrode pair has a discharge path with a linear shape.

3. A plasma display device according to claim 2, wherein the discharge path is in parallel with the phosphor layer.

4. A plasma display device according to claim 1, wherein the thickness of each electrode of the sustain electrode pair is 10 μm or more.

5. A plasma display device according to claim 4, wherein the thickness of each electrode of the sustain electrode pair is 20 μm or more.

6. A plasma display device according to claim 5, wherein the thickness of each electrode of the sustain electrode pair is 40 μm or more.

7. A plasma display device according to claim 1, wherein the thickness of the discharging gap is less than 50 μm.

8. A plasma display device according to claim 1, wherein one or two or more discharge auxiliary electrodes are located between the electrodes of the sustain electrode pair.
